(19) United States
(12) Patent Application Publication
(10) Pub. No.: US 2005/0036151 A1
(43) Pub. Date: Feb. 17, 2005

(54) Method and device for opically testing semiconductor elements

(76) Inventors: Erich Gornick, Vienna (AT); Dionyz Pogany, Vienna (AT)

Correspondence Address: LADAS & PARRY LLP, 224 SOUTH MICHIGAN AVENUE, SUITE 1200, CHICAGO, IL, 60604, US

(21) Appl. No.: 10/502,503

(22) PCT Filed: Jan. 20, 2003
(86) PCT No.: PCT/AT03/00018

(30) Foreign Application Priority Data
Jan. 25, 2002 (AT) A 124/2002

(51) Int. Cl. G01B 9/02

(52) U.S. Cl. 356/497

(57) ABSTRACT

The invention relates to a method and a device for optically testing specific internal physical parameters of semiconductor components (12) of a certain thickness (L), comprising at least one light source (1) for emitting a monochromatic light beam (2) with a wavelength (λ), to which the material of the semiconductor element (12) is at least partially transparent and comprising a beam splitter (8), for separating the light beam (2) into a reference beam (15) and a sample beam (16), and at least one detection system (41) for recording the two-dimensional images, which are generated by the interference of the light beam (20) reflected from the semiconductor clement with the reflected reference beam (25). According to the invention, the rear face (18) of the semiconductor element (12) to be tested faces the sample beam (16) and a charge device (74) is provided for emitting an external charge for the semiconductor element (12). In addition, the device is provided with a memory (81) for storing at least two interferometric images that have been recorded at intervals and with a device (133) for automatically comparing the interferometric images.

The invention relates to a method for optically testing semiconductor components of a certain thickness by using an optical interference system with at least one light source for emitting a monochromatic light beam having a wavelength, for which the material of the semiconductor component is at least partially transparent, wherein the light beam is split into a reference beam and a sample beam, the sample beam is directed at the semiconductor component, and, with the help of a detection system, the images produced by interference of the light beam reflected by the semiconductor component with the reflected reference beam are recorded for a two-dimensional illustration of certain internal physical properties of the semiconductor component.

Furthermore, the invention relates to an arrangement for optically testing semiconductor components of a certain thickness, with at least one light source for emitting a monochromatic light beam with a wavelength, for which the material of the semiconductor component is at least partially transparent, and with a beam splitter for splitting the light beam into a reference beam and a sample beam, and with at least one detection system for recording the two-dimensional images produced by the interference of the light beam reflected by the semiconductor component with the reflected reference beam.

The invention relates to the field of optical testing of semiconductor components and integrated circuits (IC) in the microelectronic industry. Such tests of semiconductor components are, e.g., used in quality checks for routine inspections for investigating internal component parameters, such as the temperature distribution or the distribution of the free carriers during external stresses, e.g. with high current pulses in case of protective structures against electrostatic discharges (ESD) or in power devices, yet also in opto-electronic components etc. Likewise, such methods may be used in the failure analysis for finding local currents and local defects in semiconductor components and in any type of materials in which local physical parameters change in time dependence and which have an effect on the local optic parameters.

The investigation of internal physical parameters, such as, e.g., the temperature, the thermal energy, the density of the free carriers, the electric field, is of substantial interest for understanding the function of semiconductor components. Particularly in protective structures against electrostatic discharge (ESD) and in power devices, the self-heating effect is the main reason for failure of the components, and therefore the localization of weak spots and the understanding of the failure mechanism are of primary interest. During the design phase of a semiconductor component or of an integrated circuit, normally simulation programs and intensive tests based on destructive failure analysis are used to predict the functionality and to estimate the reliability. Due to imprecise simulation models for the range of high currents and high temperatures, as they occur e.g. during the ESD stress in ESD protective structures, the simulation programs used cannot correctly predict the dynamics occurring under such conditions and the distribution of the internal physical parameters. On the other hand, the destructive testing of the components is time consuming and also expensive since a large number of components must be consumed. Therefore, a measurement of the internal physical component parameters with a fast, non-invasive and simple method is important.

For the performance evaluation, the verification of simulated results, and for failure analyses in semiconductor components under various types of excitation, optical methods have been developed. In many cases, it is of great interest to measure the physical parameters under a single stress pulse so as to shorten the test time and also to investigate non-repeatable phenomena. By stress pulse here any type of excitation of the semiconductor component is to be understood under which the physical parameters change.

For measuring the change of the internal physical parameters optically in bulk, semiconductor components usually are investigated from the chip backside or laterally. Since in many cases the optical access is not possible from the chip topside (e.g. due to the so-called flip-chip housings and many complex wiring levels), access from the chip backside is indispensable. For the measurement of repetitive signal courses at nodes of ICs with GHz bandwidth, a large number of different, non-invasive infrared laser probing techniques have been developed which are based on measuring the change of the refractive index or of the absorption with the change in the density of the free carriers (plasma-optical effect), the temperature (thermo-optical effect) or the electric field (electro-optical effect). Among them, interferometric backside-techniques are used, in which an infrared laser beam having a wavelength λ=1.3 μm (which is not absorbed in Si) is focused from the chip backside into the active area (e.g. channel, emitter etc.) of the components. Such methods have successfully been used in CMOS and BiCMOS components (cf. H. K. Heinrich et al.: Noninvasive sheet charge density probe for integrated silicon devices, Appl. Phys. Lett. vol. 48, 1986, pp. 1066-1068; M. Goldstein et al.: Heterodyne interferometer for the detection of electric and thermal signals in integrated circuits through the substrate, Rev. Sci. Instrum., vol. 64 (1993), pp. 3009-3013; G. N. Koskovich et al.: Voltage Measurement in GaAs Schottky barrier using optical phase modulation, IEEE Electron. Dev. Lett. vol. 9, 1988, pp. 433-435). Furthermore, a laser probing technique (λ=1.3 μm) has been used to measure the temperature dynamics and the dynamics of free carriers in power devices with a spatial resolution of 2 μm and a time resolution of 1 μs (cf. N. Seliger et al.: Time resolved analysis of self-heating in power VDMOSFETs using back-side laserprobing, Solid St. Electron., vol. 41, 1997, pp. 1285-1292).

Recently, a method for mapping the two-dimensional temperature and charge carrier density distribution has been reported (λ=1.3 μm) suitable for analysis of component behavior under single high current pulses (cf. C. Fürböck et al., Interferometric temperature mapping during ESD and failure analysis of smart power technology ESD protection devices, J. Electrostat., vol. 49, 2000, pp. 195-213). This method is based on an interferometric backside laser probing technique by which the temperature-induced or charge carrier density-induced phase shift in a focused, non-absorbed laser beam is measured. The two-dimensional imaging of the thermal energy and the charge carrier density is achieved by step-wise lateral scanning of the component surface. The stress-induced phase shift is proportional to the sum of the integrals of the temperature and charge carrier density changes along the laser beam path. The time resolution is better than 10 ns and the spatial resolution, determined by the laser wavelength, is about 1.5 μm. In a first approximation, the variation of the optical phase in the laser beam can be described as a change of the optical path, caused by a change in the temperature and in the electron and hole density at a time t (represented by T(x, y, z, t) cₙ(x, y, z, t), C_{P}(x, y, z, t)), based on time t₀ (represented by T₀, cₙ(x, y, z, t₀), cₚ(x, y, z, t₀), equilibrium state, e.g. ambient temperature without stress on the component):

$$Δφ ( t ) = 2 \cdot 2 \frac{π}{λ} \int Δ n ( T , {c}_{n} , {c}_{p} ) ⅆ z \qquad ( 1 a )$$

where
Δn(T, cₙ, cₚ)=n(T, cₙ, cₚ)|ₜ−n(T, cₙ, cₚ)|ₜ₀ (1b)
where n(T, cₙ, cₚ)|ₜ and n(T, cₙ, cₚ)|ₜ₀ is the refractive index of the semiconductor material at time t and t₀, and the integration is effected along the laser beam path (z-axis, the laser beam is perpendicular to the chip surface, the axes x and y form the lateral plane). The factor 2 on the right-hand side of equation (1a) arises from a double passage of the laser beam through the semiconductor substrate. This equation for phase shift only applies if the multiple reflections between the chip topside and the polished backside can be neglected. In practice, this can be achieved by applying an antireflection coating on the chip backside or by using a high numerical aperture microscope objective and a spatial filter. The dependence of the refractive index on the temperature and on the charge carrier density can be found in the literature (McCaulley et al., Phys. Rev. B., 49 (1994), pp. 7408-7417), Soref et al., IEEE J. Quant. Electron, 23 (1987), pp. 123-129)). The change in the refractive index with the electric field is neglected. In silicon, the refractive index is not dependent on the electric field (centrosymmetric semiconductor), and the temperature and charge carrier effects dominate. Furthermore, the effect of the thermal expansion on the phase shift is neglected, since the effect on the change in the optical path usually is smaller by two orders of magnitude than that of the temperature variation and the charge carrier density change (in semiconductors such as Si and GaAs).

Measuring the temperature and charge carrier distribution via phase shift is suitable for a quantitative analysis of these parameters because the refractive index depends nearly linearly on temperature and charge carrier density. The two contributions to the phase shift can be distinguished according to their signs because the temperature contribution and the charge carrier contribution have different signs. In those cases in which the temperature contribution dominates, the temperature-induced phase shift, in the first approximation, is proportional to the thermal energy in the laser-beam-filled volume. Therefore, the determination of the phase shift actually is a measure of the energy density. The lateral resolution for the imaging of two heat sources is determined by the thermal diffusion length, and in silicon, e.g., for a 100 ns long stress pulse it is approximately 3 μm (Lₜₕ=3 μm·\sqrt{t/100 ns}, where t is the length of the stress pulse). This shows that by imaging the energy density under short stress pulses it becomes possible to localize heat sources within the thermal diffusion length. When actuated with longer stress pulses or with direct current, the temperature distribution becomes much broader and thus, the thermal resolution ability is reduced.

Repetitive electrical signals in ICs have also been measured from the substrate backside with a laser beam probe (λ=1064 nm), where the modulation of the laser beam intensity is caused by the variation of the electro-absorption with the electrical activation of the component (S. Kasapi et al.: Laser beam backside probing of CMOS integrated circuits, Microel. Reliab. vol. 39 (1999), pp. 957-961; M. Paniccia et al.: Optical probing of flip chip packaged microprocessors, J. Vac. Sci. Technol. B, vol. 16, 1998, pp. 3625-3630): Based on this principle, a commercial device (IDS2000) for backside measurement of repetitive electrical signals with picosecond time resolution at the nodes in integrated circuits has been developed and put on the market by Schlumberger. Due to a low sensitivity of the method, the measuring signal must be averaged over a long period (minutes), and the component must be exposed to frequently repeated stress pulses.

In a first approximation, the change in the relative intensity ΔI/I which occurs in the reflected laser beam due to the change of the absorption (caused by the variation of temperature, the electron and hole density) from time t₀ to time t, can be described by:

$$\frac{( Δ I )}{I} = 1 - exp \{ - 2 \int [ α ( T , {c}_{n} , {c}_{p} ) {\vert t - α ( T , {c}_{n} , {c}_{p} ) \vert}_{t0} ] ⅆ z ] , \qquad ( 2 )$$

where α(T, cₙ, cₚ)|ₜ and α(T, cₙ, cₚ)|ₜ₀ are the absorption coefficients at times t and t₀. I is the constant light intensity which depends on the reflectivity of the component. Due to the exponential term in equation 2, the relative intensity change ΔI/I, for large values of temperature or charge carrier density, will be insensitive to variations in these parameters. Therefore, the measurement of the absorption is not useful for a quantitative analysis of the internal component behavior. On the other hand, the measurement is relatively simple to do. To increase the sensitivity of the instrument for the inspection of voltage pulses on component nodes in ICs, Schlumberger has developed the device IDS2500 which is based on a Michelson Interferometer and measures the refractive index by a focused laser beam. This method is directed at the circuit failure analysis, and for this it requires a high repetition frequency of the pulses.

The changes in the temperature and in the charge carrier density during current pulses in semiconductor components have also been investigated with the so-called “Mirage” technique, in which a laser beam probe penetrates the component from one side (G. Deboy et al.: Absolute measurements of transient carrier density and temperature gradients in power semiconductor devices by internal IR-laser deflection, Microel. Eng., vol. 31, 1996, pp. 299-307). The laser beam deflection due to the temperature or charge carrier-induced refractive index gradient in the component is measured. The distribution of the temperature and the charge carrier density are imaged by scanning the component. R. A. Sunshine et al. (“Stroboscopic investigation of thermal switching in an avalanching diode”, Appl. Phys. Lett., vol. 18, 1971, pp. 468-470) and W. B. Smith et al. (“Second breakdown and damage in junction devices”, IEEE Tr. ED, vol. 20, 1973, pp. 731-744) have reported a stroboscopic method for measuring the temperature increase and of current filaments during the avalanche breakthrough in semitransparent thin film transistors prepared on sapphire substrate. The spatial temperature distribution in the component during the stress with the current pulse has been measured via the observation of the absorption change in the component. The component is stressed with a frequency of about 20 Hz (resulting in a corresponding heating) and illuminated with the same frequency. A broad-band, white light source (e.g. a Xenon flash lamp) is used for illumination. The duration of illumination (20 ns) is much shorter than the duration of the current pulse (>>10 μs). Due to the long screen memory of the cathode material, the transmission image of the component could be recorded with a vidicon camera. By varying the delay between the current pulse and the illumination, the images could be recorded at various time windows. This method has been developed for transmission images and is restricted to components which are transparent to visible light. Therefore, the method cannot be used for imaging components on semiconductor substrate, where light in the infrared range must be used.

U.S. Pat. No. 4,841,150 describes a method of imaging temperature distributions in semiconductor components, in which an expanded, reflected light beam is used. The method is based on the spectral analysis of the reflectivity change due to the temperature-induced change in the absorption. The method has been developed for measuring the temperature distribution under direct current stress on wafer level during individual production processes and cannot be used for time-resolved measurements of internal physical properties of individual components.

D.C. Hall et al. (“Interferometric near field imaging technique for phase and refractive index profiling in large-area planar-waveguide optoelectronic devices”, IEEE J. Sel. Top. Quant. Electron, vol. 1, 1995, pp. 1017-1029) describe a method of imaging the spatial changes in the refractive index in a planar waveguide by means of interferometry using an expanded IR laser beam (λ=910 nm). A Mach-Zehnder interferometer was used, where the laser beam of the sample arm of the interferometer passes through the sample and interferes with the laser beam of the reference arm. The interference image is recorded by a CCD (charged coupled device) camera. The spatial distribution of the refractive index change is obtained by comparing the phase distribution extracted from the interference images, when heated and when not heated. Also this method operates with light transmission through the component and is not suitable to investigate semiconductor components in a wafer.

Methods and apparatuses for the non-contact measurement of the substrate temperature based on laser interferometry are described in U.S. Pat. No. 5,229,303 and in U.S. Pat. No. 5,773,316. The temperature measurement in these methods is effected by measuring the change in the intensity of a reflected or transmitted light beam which impinges on a semiconductor substrate. This is caused by the change in the optic path as a consequence of the temperature-induced change in the refractive index. In the substrate, the light beam experiences multiple reflections, producing interference maximums and minimums from which the temperature can be extracted. By using a slightly tilted substrate or two different laser wavelengths, the sense in the temperature change can be obtained by measuring the movement direction of the interference fringes or by measuring the direction of the intensity change in two laser beams of different wavelengths. In this method, the interference fringes are produced by the interference within the substrate. This method is not suited for measuring the temperature in semiconductor components, since the multiple reflections within the component are a disturbing factor, rendering a quantitative analysis impossible.

In U.S. Pat. No. 6,181,416 a method and an apparatus for imaging the temperature and the charge carrier density in semiconductor components has been described which is based on the so-called Schlieren method, an imaging method based on imaging the refractive index gradient. The apparatus can produce an image of the component also from the chip backside, the temporal resolution being dependent on the duration of the illuminating laser pulse. The angular deflection of the laser light due to the refractive index gradient is transformed into a change of the light intensity in the image of the component. By comparing the images captured in the switched off state and in the switched on, active state of the component, the spatial distribution of the changes in temperature and charge carrier density can be derived within a certain time window. It is, however, difficult to obtain quantitative evaluations of the internal physical parameters (temperature, thermal energy, charge carrier density) with this method. Likewise, the time course of the measurement set-up does not allow triggering of the illumination pulse by the stress pulse which causes the change in the component temperature or free carrier density.

A further principle of the temperature measurement in semiconductor components is the evaluation of the black body radiation (I. P. Herman: Real time optical thermometry during semiconductor processing, J. Sel. Top. Quantum Electron, vol. 1, 1995, pp. 1047-1053). Since the wavelength is in the range of from 3 to 10 μm, the spatial resolution of this method is limited. Furthermore, the method requires a complex calibration, and multiple reflections within the semiconductor component must be taken into consideration. Methods for measuring the temperature in semiconductor components by means of the black body radiation are described e.g. in EP 0 618 455, WO 99/28715 or EP 0 880 853.

The current distribution in a semiconductor component can also be qualitatively obtained by measurement of the light emission from the component (M. Hanneman et al.: “Photon emission as a tool for ESD failure localization and as a technique for studying ESD phenomena”, Proc. ESREF, 1990, pp. 77-83, J. Költzer et al.: “Quantitative emission microscopy”, J. Appl. Phys., vol. 71, 1992, pp. R23-R41). The emission is caused by the radiating transitions of the electrones and the holes and by the emission of hot charge carriers (‘hot carrier emission’, bremsstrahlung, charge carrier recombination etc.). One method for analyzing integrated circuits with time resolution in the range of picoseconds has been developed for the backside measurement of signal courses in CMOS circuits (M. K. McManus et al.: “PICA: Backside failure analysis of CMOS circuit using picosecond imaging circuit analysis”, Microel. Reliab., vol. 40, 2000, pp. 1353-1358). This method is based on the stroboscopic imaging of the emission radiation which occurs during the high-frequent cyclic switching of the components. For this, the images of a CCD camera are averaged over a longer period (hours). Such a method which is relevant for the emission microscopy or the microscopy in the bulk of an integrated circuit has been described, e.g., in U.S. Pat. No. 6,222,187.

Optical method for failure analysis in integrated circuits from the chip topside have been described e.g. in U.S. Pat. No. 4,682,605 and in GB 2,217,011. In the fluorescent microthermic mapping, the local heating by heat dissipation at the site of a fault through an organic layer applied to the topside of the IC is indicated. However, the precision of the method is greatly reduced if the fault site is located deep within the substrate and/or if the IC has a large number of metallization layers. Furthermore, this method cannot be applied if the IC is incorporated in a flip-chip housing.

Holographic interferometry often is used for the (also time-resolved) imaging of surface topologies, displacement, changes in the refractive index or other time-dependent changes in objects and also in interference microscopes by the inspection of the surfaces of semiconductor components (cf. P. C. Montgomery et al., “Phase stepping microscopy (PSM): a qualification tool for electronic and optoelectronic devices”, Semicond. Sci. Technol. vol. 7, 1992, pp. A237-A242; K. Snow et al., “An application of holography to interference microscopy”, Appl. Optics, vol. 7, 1968, pp. 549-554). Such a method has been described e.g. in U.S. Pat. No. 4,818,110. By using the above-mentioned methods, the surface topography or the height of the surface structures of semiconductor components can be determined from the change of the interference fringes which is a function of the phase change of a monochromatic light beam. Likewise, the height of the surface structure of a semiconductor component can be determined via the degree of coherence of a broad-band light beam. In none of the known methods, the holographic interferometry is used for two-dimensional imaging of the refractive index changes in the interior of the semiconductor material of a semiconductor component.

For the time-resolved interferometric analysis of vibrating objects, a stroboscopic method has been employed (P. Shajenko et al.: “Stroboscopic holographic interferometry”, Appl. Phys. Lett. vol. 13, 1968, pp. 44-46S, Nakadate et al.; “Vibrational measurements using phase-shifting stroboscopic holographic interferometry”, Optica Acta, vol. 33, 1986, pp. 1295-1309). For the extraction of the phase from interference fringes, various methods have been proposed which are based, e.g., on the Fast Fourier Transformation (FFT) and phase unwrapping (cf.: T. Kreis: “Digital holographic interference-phase measurements using the Fourier-transform method”, J. Opt. Soc. Am. A vol. 3, 1986, pp. 847-855; M. Takeda: “Fourier-transform method of fringe-pattern analysis for computer-based topography and interferometry”, J. Opt. Soc. Am. vol. 72, 1982, pp. 156-160).

A disadvantage of all scanning methods, such as interferometry, the Mirage technique and the absorption, is the necessity of repeatedly subjecting the semiconductor component to stress pulses so as to produce an image. Due to the cumulative stress, this may lead to the destruction of the component.

Therefore, one object of the present invention consists in providing a method for optically testing semiconductor components of the indicated type, which can be carried out as rapidly and simply as possible so that the semiconductor component to be tested is stressed as little as possible. The method should furthermore also be characterized by a particularly high sensitivity regarding the changes of certain physical properties within the semiconductor component. Disadvantages of known methods are to be avoided or reduced.

The object according to the invention is achieved in that the sample beam is directed at the backside of the semiconductor component to be tested and reflected at its topside, and that at least two interference images are detected in temporal sequence under different states of stress of the semiconductor component.

By investigating the component from the substrate backside, also the testing of semiconductor components, in which the optical access from the topside is now possible, is allowable. The optical interference system may, e.g., be realized by a Michelson interferometer. The sample beam passes through the semiconductor component, is reflected on the topside of the component, and returns through the component towards the beam splitter. Now the reflected beam contains information on the change of the refractive index within the semiconductor component and on the change of the reflectivity of the topside of the semiconductor component. By the interference of the sample beam with the reflected reference beam which has been produced by reflection on a mirror or on a semiconductor component that is identical with the semiconductor component to be tested, an interference image is produced which is recorded by a suitable detection system. From the interference image, the phase profile can be extracted, in which the refractive index profile and the morphology of the semiconductor component are contained. The phase profile correlates with the time-dependent change of the refractive index. The changes of the refractive index are caused by a change of the temperature and/or of the free carrier density within the semiconductor component. The phase change measured is determined by the integral of the refractive index change along the optical path of the light beam in the semiconductor component. In this manner, images of the temperature distribution and of the distribution of the charge carrier density can be produced.

By the detection of at least two interference images, an investigation of the internal physical properties of the semiconductor component to be tested can be imaged under different stress conditions in dependence on time. The image is obtained via imaging the phase shift caused by the refractive index change in the interior of the semiconductor component. The method according to the invention allows for a time-resolved two-dimensional representation of refractive index changes within the volume of a semiconductor component or of a circuit. Provided that short light pulses and/or very rapid detectors are used, extremely high time resolutions within the nanosecond range are attainable.

For qualitative evaluations during the optical testing of semiconductor components, light beams of almost arbitrary coherence lengths can be used. For the quantitative analysis of semiconductor components it is advantageous if the coherence length of the light beam split into sample beam and reference beam is less than the optical path length 2·L·n of the semiconductor component to be tested, where L is the thickness and n is the mean refractive index of the material of the semiconductor component. By using a light beam whose coherence length is shorter than the optical path length of the semiconductor component to be tested, a correct interferogram is obtained which is determined by the effects of the interesting internal physical properties of the semiconductor component and not falsified by multiple reflections through the component surface. The use of a sufficiently short coherence length and the thus caused elimination of the influence of multi-beam interferences within the semiconductor component simplify the arrangement, since an anti-reflection coating on the backside of the semiconductor component can be avoided. Such a coating is very expensive and complex and would render the method for optically testing semiconductor components more difficult. By the elimination of undesired interferences, a quantitative analysis of the data and an unambiguous interpretation are possible.

If according to a further feature of the invention, the diameter of the sample beam is adjusted, it can be achieved that the desired area of the semiconductor component is covered by the sample beam so that a measurement for the entire area to be examined will result. The adjustment of the diameter of the sample beam can be effected with appropriate beam expanders or Galileo microscopes in conventional manner.

Advantageously, the detected interference images are stored, the data preferably being digitized before being stored, e.g. by means of a video-tape recorder or a computer.

In doing so, the different states of stress are caused by excitation of the semiconductor component with at least one external stress, by which certain properties of the semiconductor component are influenced, and at least one light beam is emitted during the external stress and a respective interference image is detected. By comparing temporally consecutive interference images in dependence on the stress, important information can be obtained on certain physical properties of the semiconductor component in dependence on the stress. In doing so, the semiconductor component can be investigated without applied stress and with applied stress or with different applied stresses.

Preferably, the external stress is caused by high voltage or high current pulses. Likewise, flashes of light may be used as external stress sources for the semiconductor components to be tested.

In order to obtain time-resolved interference images of the semiconductor components for individual stress pulses, preferably several light beams are emitted before, during and/or after the stress and the corresponding interference images are detected. By subtracting the phase profile extractable from the interference images before the external stress and during the external stress, a phase profile correlating with the time-dependent change of the refractive index can be determined, and thus internal physical parameters of the semiconductor components, such as temperature or free carrier density, can be imaged in dependence on the time during the individual stress pulses. By the external stress pulse, free carriers and/or a local heating are produced in the semiconductor component.

To allow for the external stress to occur arbitrary in time, e.g. in order to be able to simulate incidental stresses, it is provided for the stress to be detected and for at least one light beam to be triggered at a pre-defined time after the detection of the stress.

To measure the temperature or the distribution of the charge carrier density in the semiconductor component during a stress, also a light beam of longer duration may be emitted at least during the stressed state, and several interference images may be detected before, during and/or after the stressed state. This is a variation to using several light pulses, wherein several temporally consecutive interference images can be recorded, e.g. by means of so-called gated detection systems.

To increase the quality of the measured data, the backside of the semiconductor component may be polished before optical testing.

In order to be able to detect several temporally consecutive interference images, the resulting interfering light beams can be split, and the split partial beams can be recorded by individual detection systems. In this way, interference images may be recorded at two or several points of time by different detection systems.

In doing so, the detection system can be activated in dependence on the emitted light beams, and the emitted light beams may have different polarizations, preferably orthogonal polarization, or different wavelengths. The light beam can then be separated in dependence on its properties (polarization, wavelength) and recorded by separate detection systems at any time segment. By comparing the interference images, the information regarding the behavior of the semiconductor component in dependence on the different stresses can be obtained.

Instead of being reflected on a commonly used reference mirror, the reference beam may also be reflected on a reference semiconductor component, wherein the reference semiconductor component is identical with the semiconductor component to be tested and is not subjected to any external stress during the testing procedure.

If the intensity of the reference beam is attenuated, the contrast of the interference fringes in the interference image can be optimized.

If the position of the reflected reference beam is changed, e.g. by tilting of the reference mirror, the distance of the interference fringes in the interference image can be adjusted.

Preferably, the temporally consecutively recorded interference images are automatically compared to each other so that the information on the desired physical parameters of the semiconductor component can be obtained and analyzed rapidly.

A further object of the invention consists in providing an arrangement for optically testing semiconductor components of the type indicated, whose construction is as simple as possible and which yields reliable measurement results.

This object is achieved in that the backside of the semiconductor component faces the sample beam, that a stressing device for emitting an external stress for the semiconductor component is provided, and that furthermore a memory for storing at least two interference images recorded at time intervals, and a device for automatically comparing the interference images are provided. By this arrangement, the time resolved image of certain physical parameters, such as the temperature or the free carrier density, in semiconductor components is possible from the backside of the chip. By the stressing device for emitting an external stress for the semiconductor component, which may, e.g., be formed by a high voltage or high current source or by a light source for emitting intense flashes of light, it is possible, in particular for the failure analysis, to investigate the behavior of the semiconductor component in case of stress. A memory is provided so as to store the recorded interference images and for a subsequent mathematical recording, which memory may, e.g., be formed by a video-tape recorder or by an appropriate computer. For comparing the temporally consecutively recorded interference images more easily and more rapidly, a device for automatically comparing the stored interference images is provided.

In order to be able to image and analyze the entire semiconductor component to be tested in one single measurement procedure, preferably a device for adjusting the diameter of the emitted light beam to the area of the semiconductor component to be investigated is provided in front of the light source. For instance, this device may be realized by a beam expander for enlarging the diameter of the emitted light beam, or by a microscope of reducing the diameter of the emitted light beam. A beam expander is formed e.g. by the arrangement of lenses of certain focal lengths.

To allow for recording the interference images in dependence on incidentally occurring stress pulses, the stressing device preferably is connected to a device for controlling the light source which is capable of controlling the emission of light beams and thus, the starting of measurements on the semiconductor component in time dependence on the stress pulse.

In this connection, the control device may comprise a delaying device so that the measurement can be triggered at a certain time interval after introduction of the stress pulse.

According to a further feature of the invention it is provided for the detection system to comprise a beam separator for separating the light beams into individual light beams with different light parameters, and one camera each for recording images of these individual light beams.

In order to differentiate between the emitted light beams when using several cameras, the beam separator may comprise a polarizing device for separating the light beams into individual light beams with different polarizations.

Likewise, the beam separator may comprise dichroic beam splitters for splitting the light beams into individual light beams with different wavelengths.

To improve the measurement results, a collimator may be arranged in front of the semiconductor component for parallel adjustment of the sample beam.

To optimize the contrast of the interference fringes in the resultant interference image, an attenuator may be arranged in the path of the reference beam.

By providing a device for changing the position of the reflected reference beam which may be formed by a device for easy tilting of the reference mirror, it is possible to adjust the distance of the interference fringes in the interference image.

The device for automatically comparing the stored interference images may also be formed by an appropriate computer.

Preferably, the light source of a monochromatic light beam is formed by a laser.

The detection device may, e.g., include a vidicon or a CCD camera, or also a two-dimensional multi-element detector. Also detector arrays are suitable for an appropriate detection of two-dimensional interference images.

The invention will now be explained in more detail by way of the enclosed drawings.

Therein,

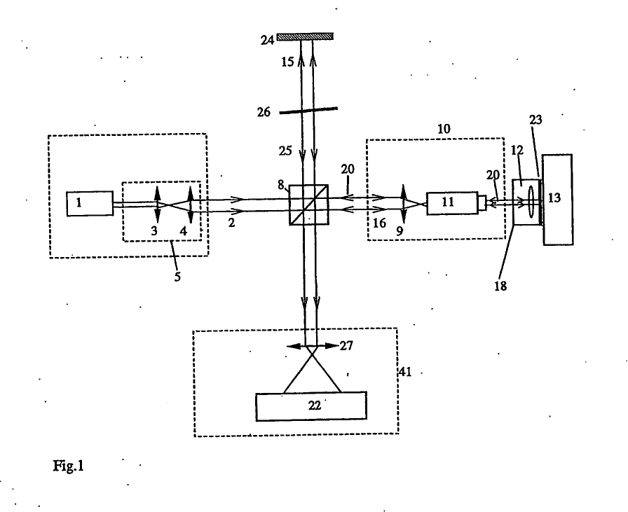

FIG. 1 shows a block diagram of an arrangement for optically testing semiconductor components;

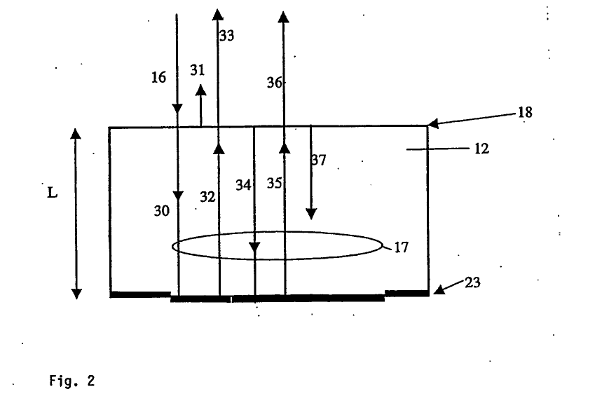

FIG. 2 shows a schematic cross-section through a semiconductor component, which is penetrated by light beams;

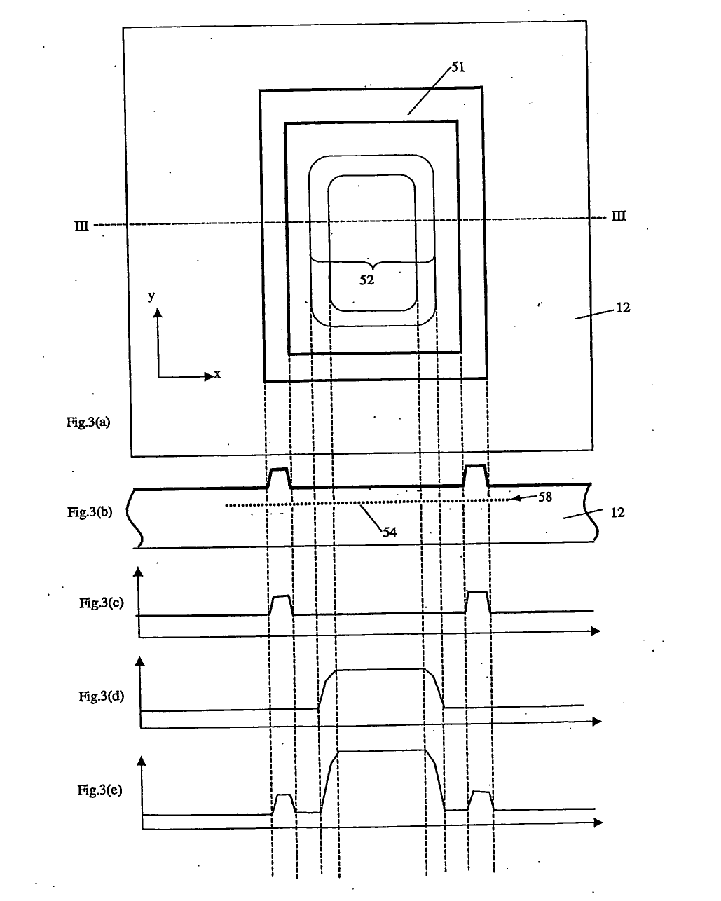

FIG. 3a is a top view on a semiconductor component with a surface morphology on the topside;

FIG. 3b is a section through the semiconductor component according to FIG. 3a, along sectional line III-III;

FIG. 3c is the optical phase shift along sectional line III-III in FIG. 3a which is caused by the morphology of the topside of the semiconductor component;

FIG. 3d shows-the course of the refractive index along sectional line III-III in the stressed state; and

FIG. 3e shows the course of the optical phase shift along sectional line III-III in the semiconductor component, which is caused by the combined effect of the surface morphology on the topside of the semiconductor component and by the change of the refractive index in the component;

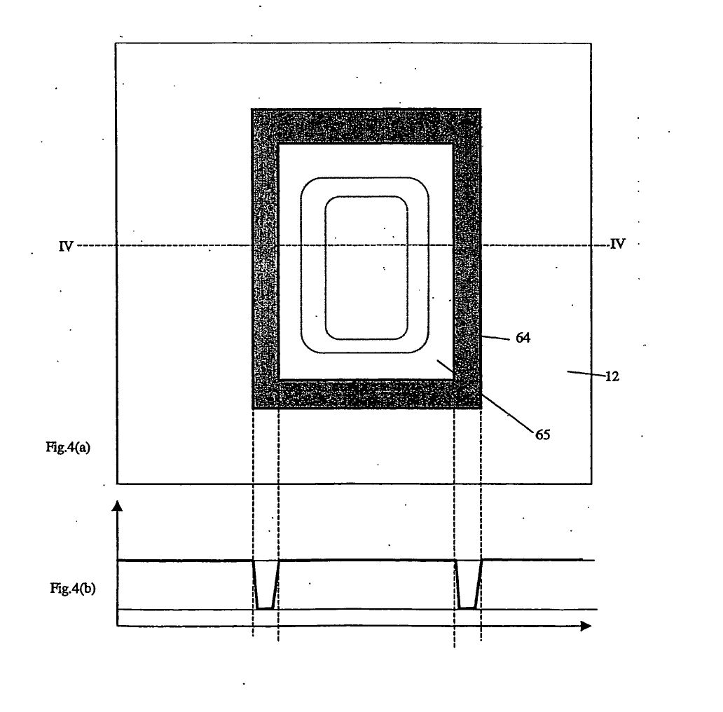

FIG. 4a shows an example of an interference image of the semiconductor component which is caused by the morphology of the component and by the course of the refractive index in the unstressed state according to FIG. 3a, and

FIG. 4b shows the course of the light intensity along line IV-IV in FIG. 4a;

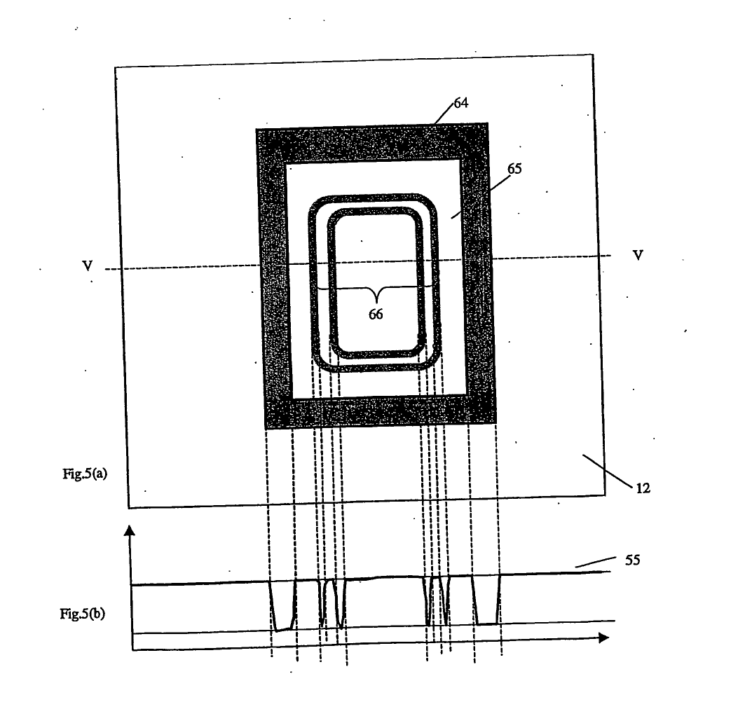

FIG. 5a shows the example of an interference image of a semiconductor component with the influence of the surface morphology and the course of the refractive index in the excited state according to FIGS. 3a and 3e, and

FIG. 5b shows the course of the light intensity along line V-V of FIG. 5a;

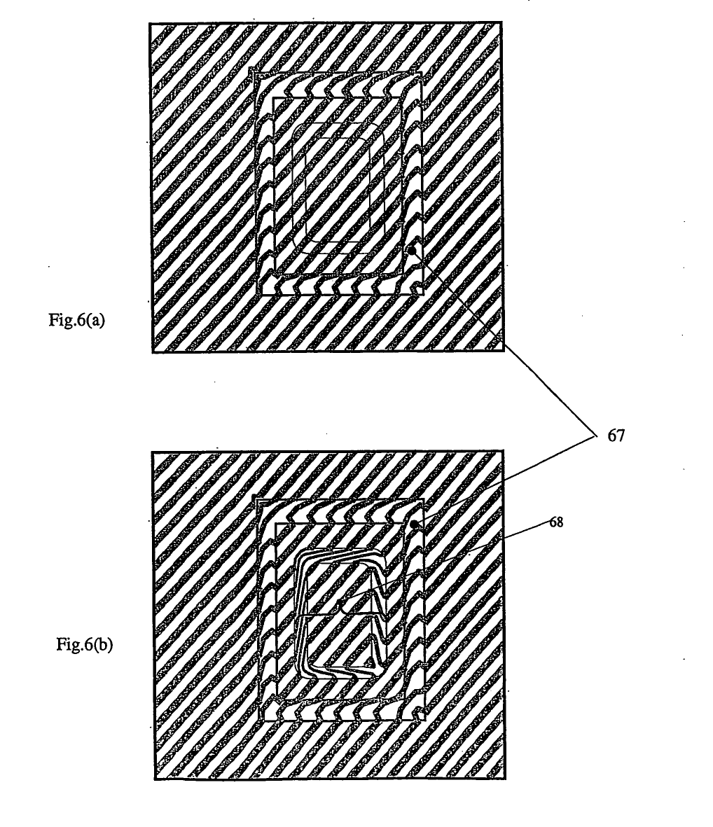

FIG. 6a shows an example of an interference image of a semiconductor component with the influence of the surface morphology and the course of the refractive index in the unstressed state, and

FIG. 6b shows the interference image according to FIG. 6a with the influence of the surface morphology and the course of the refractive index in the excited state;

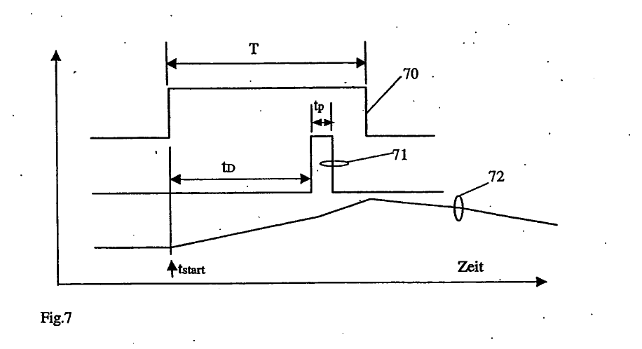

FIG. 7 shows the schematic time courses of the signals while using the method for optically testing a semiconductor component under stress;

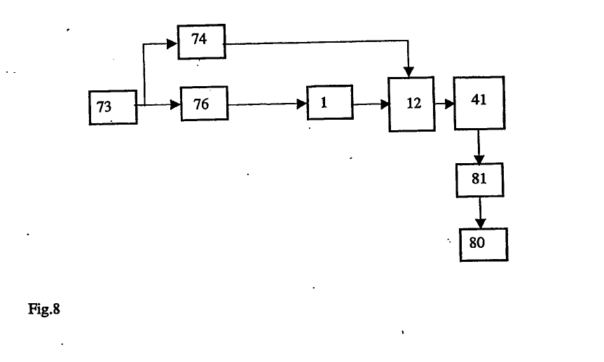

FIG. 8 shows a simplified block diagram of an arrangement for optically testing semiconductor components;

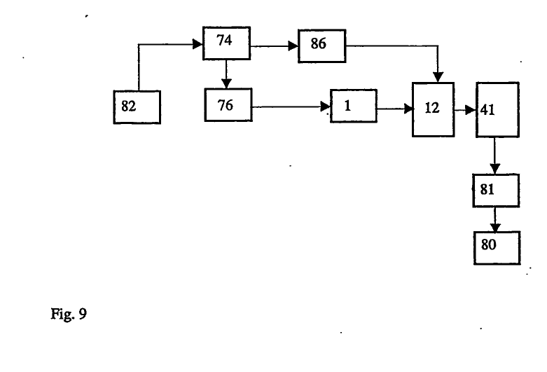

FIG. 9 shows a variant of an arrangement for optically testing semiconductor components;

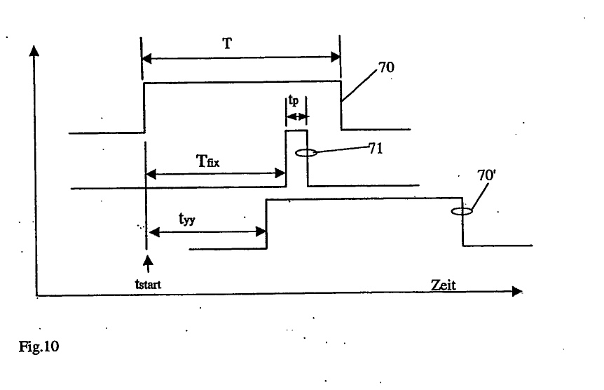

FIG. 10 shows the schematic time courses of the signals while measuring with an arrangement according to FIG. 9;

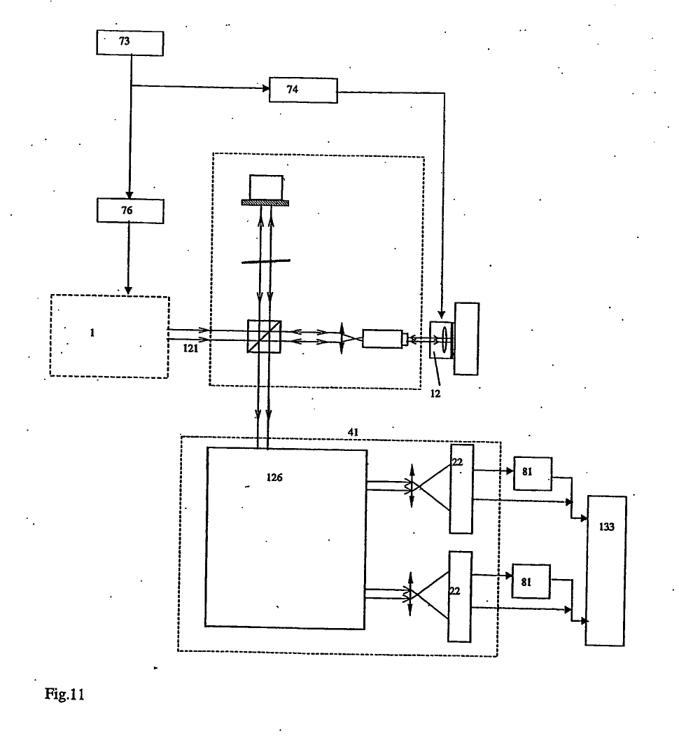

FIG. 11 shows the block diagram of an arrangement for optically testing semiconductor components using two detection systems;

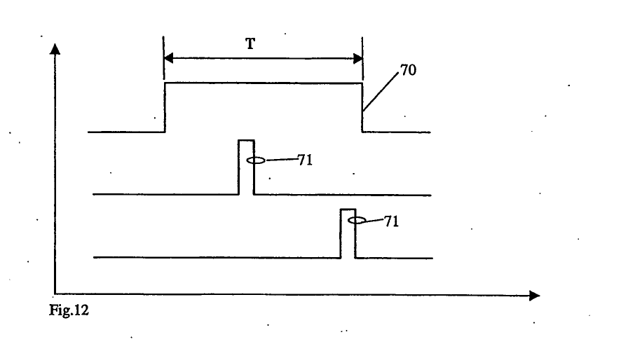

FIG. 12 shows the schematic time courses of the stress pulses and the light pulses while carrying out the method with an arrangement according to FIG. 11;

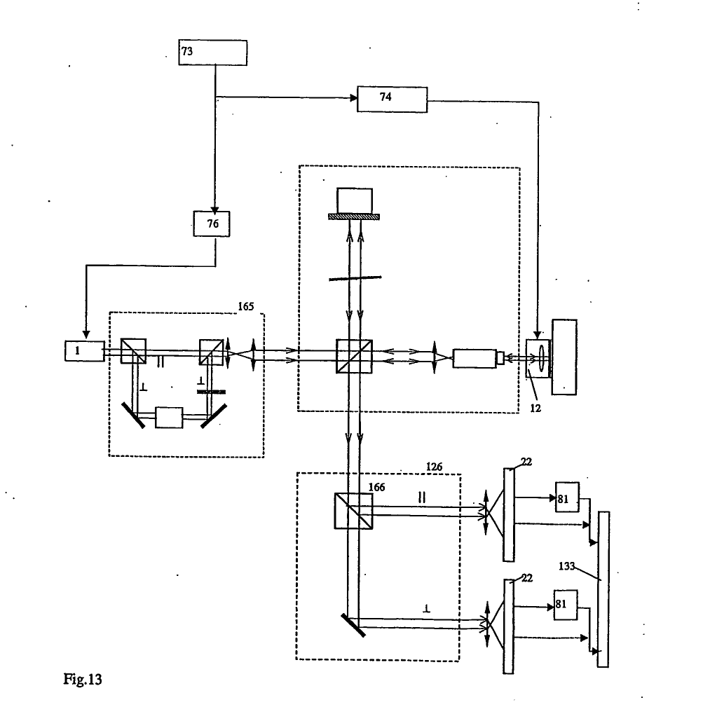

FIG. 13 shows a variant of a testing arrangement using light beams of different polarizations;

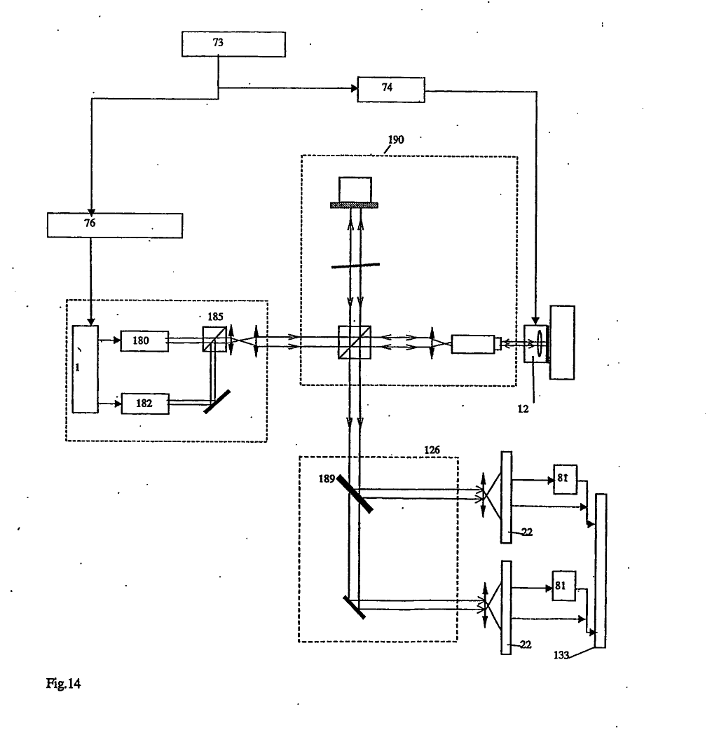

FIG. 14 shows a variant of a testing arrangement using two light sources of different wavelengths;

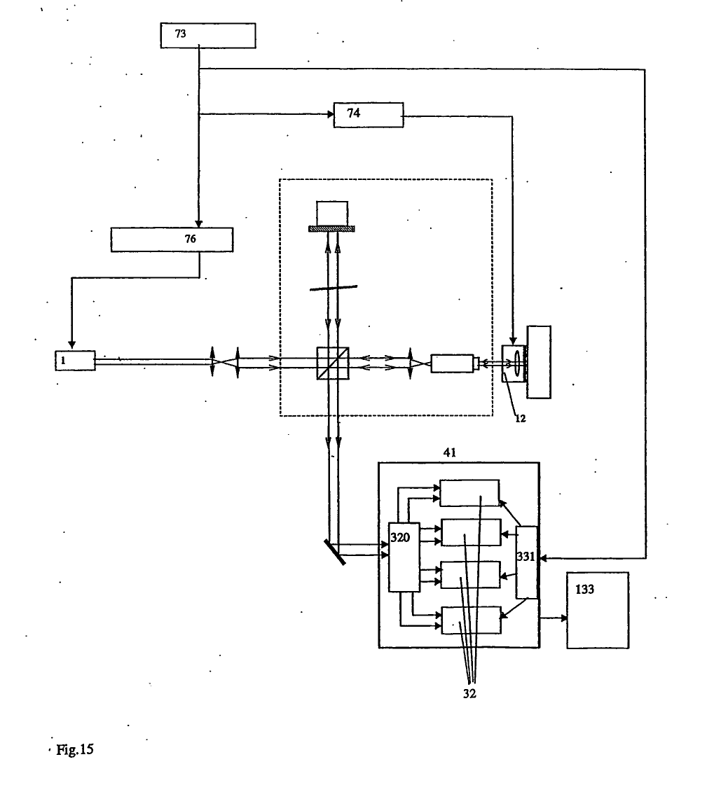

FIG. 15 shows a further variant of a testing arrangement using a light source in long pulse operation and a time-controlled detection system; and

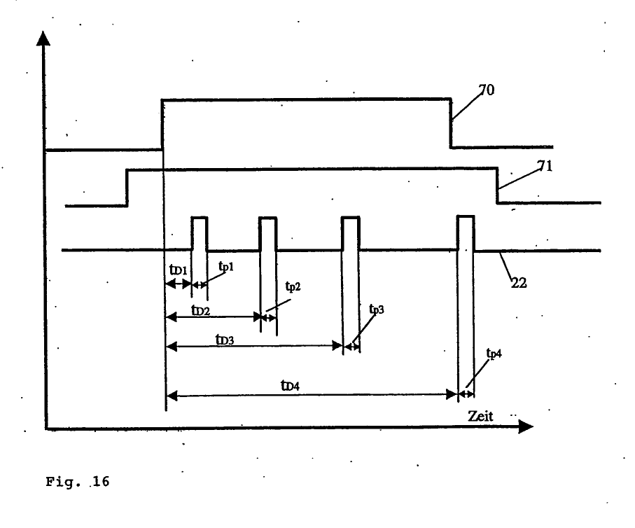

FIG. 16 shows a diagram of the temporal sequence of the signals during a measurement by aid of the arrangement according to FIG. 15.

FIG. 1 shows a block diagram of an embodiment of an arrangement for optically testing semiconductor components using an optical interference system. The arrangement consists of at least one light source 1 for emitting a monochromatic light beam 2 having a wave length λ, for which the material of the semiconductor component 12 to be tested is at least partially transparent. The emitted monochromatic light beam 2 can pass through a beam expander 5, which may, e.g., consist of appropriately arranged lenses 3 and 4 and serves to expand the beam diameter of light beam 2. In a beam splitter 8, the emitted monochromatic light beam 2 is split into a sample beam 16 and a reference beam 15. The sample beam 16 is directed towards the backside 18 of the semiconductor component 12 and passes through the semiconductor component 12 and is reflected at the topside 23 thereof, whereupon it passes the semiconductor component 12 once more, and the reflected light beam 20 emerges at the backside 18 of the semiconductor component 12. The sample beam 16 can pass through a collimator 10 consisting, e.g., of a lens 9 and an objective 11. The backside 18 of the semiconductor component 12 may be polished to optical grade. The light beam 20 reflected by the semiconductor component 12 contains the information on the spatial distribution of the phase shift caused by the modulation of the refractive index n in the semiconductor component 12 and by the morphology on the topside 23 of the semiconductor component 12. If the refractive index n is also subjected to a temporal change in the semiconductor component 12, the reflected light beam 20 will also contain the information on the temporal development of the refractive index n within the semiconductor component 12. The diameter of the sample beam 16 impinging on the semiconductor component 12 will depend on the diameter of the emitted light beam 2 and may be adjusted by the beam expander 5 and the possibly present collimator 10. The semiconductor component 12 can be arranged on a table 13 which can be moved in different directions. The light beam 20 reflected by the semiconductor component 12 is reflected on the beam splitter 8 and directed at the detection system 41. Reference beam 15 is reflected by a reference mirror 24 and produces light beam 25 which also passes through the beam splitter 8 and impinges on the detection system 41. By the superposition of the light beam 20 reflected by semiconductor component 12 and the light beam 25 reflected on the reference mirror 24, an interference image is produced which may be viewed, e.g. through a camera 22 with a preceding lens 27 of the detection system 41, and recorded. The position of the interference maximums and minimums in the interference image will depend on the spatial distribution of the optical wavelength difference (phase) between the reference beam 15 and the sample beam 16. By the arrangement of an attenuator 26 between the reference mirror 24 and the beam splitter 8, the contrast of the interference lines in the interference image can be optimized. By tilting the reference mirror 24, the spacing of the interference lines in the interference image can be adjusted. The arrangement illustrated in FIG. 1 for optically testing semiconductor components 12 uses a Michelson-type interferometer. Yet also other types of an interferometers may be used (e.g. Mireau or Linic) so as to produce an interference image of semiconductor component 12. An interference image may be observed in camera 22 of detection system 41, if the difference in the optical wavelengths of the sample beam 16 and the reference beam 15 is within the coherence length L_{Coh} of the light source 1 used.

FIG. 2 shows a detailed illustration of the light paths in a semiconductor component 12 having the thickness L in cross-section, a light beam 16 impinging on the backside 18 of semiconductor component 12 being illustrated. Within the semiconductor component 12, a range 17 is shown in which a change of the refractive index n, e.g. by an external stress pulse, has been caused. On the topside 23 of semiconductor component 12, a change in the surface morphology has been sketched. The light beam 16 impinging on the backside 18 of the semiconductor component 12 is split into a light beam 30 penetrating into semiconductor component 12 and a light beam 31 reflected at the backside 18. The penetrating light beam 30 is reflected at the topside 23 of semiconductor component 12. This reflected light beam 32 once more passes through semiconductor component 12 and partially passes through the backside 18 to the outside and forms light beam 33, yet partially it is reflected on the backside 18 of semiconductor component 12, whereupon a light beam 34 again passes through the semiconductor component 12 towards its topside 23. At the topside 23 of semiconductor component 12, this light beam 34 again is reflected and forms a light beam 35 which partially emerges from semiconductor component 12 (light beam 36) and partially once more is reflected at the backside 18 of semiconductor component 12 (light beam 37) etc. In optics, this procedure is known as multiple reflection. The light beam reflected by the semiconductor component 12 therefore is a complicated sum of contributions of light beams 31, 33 and 36 according to FIG. 2. The spatial distribution of the phase and the intensity in the reflected beam is determined by the morphology and reflectivity at the topside 23 and by the variation of the refractive index n in area 17 and by the absorption in the substrate of semiconductor component 12 and by the reflectivity of the backside 18 and the thickness L of the substrate of semiconductor component 12. This results in a highly complicated function.

It is a central aspect of the invention to eliminate the influence of the reflectivity of the backside 18 of semiconductor component 12, and to thereby make it possible to set the measured phase shift in a direct relationship to the change of the refractive index in region 17. This can be achieved either by applying an anti-reflection coating on the backside 18, or by using light with a precisely chosen coherence length for producing the interference image. Application of an anti-reflection coating is difficult and too cumbersome for an industrial application of the method. For quantitative assessments in the optical investigation of semiconductor components, preferably light beams 2 having a coherence length L_{Coh} are used which is shorter than the optical path length 2·L·n of semiconductor component 12 to be tested, L being the thickness and n being the mean refractive index of the material of semiconductor component 12. Furthermore, preferably a wavelength λ of the light beam 2 emitted by the light source 1 is chosen such that the energy of the photons is lower than the band spacing of the material of semiconductor component 12. The intensity of the reflected beam 20 must be high enough so as to be detected by camera 22. For silicon, e.g., the wavelength may be in the range of from 1.1 μm to 2 μm, for gallium arsenide it may be in the range of from 980 nm to 1.5 μm. For silicon, the optimum wavelength is at 1.3 μm to 1.5 μm, since this is far from the absorption edge, and the band-to-band absorption is negligible also at higher temperatures (500-700K) enabling the recording of interference images at these temperatures without disturbing absorption. The use of even longer light wavelengths is not meaningful due to a decrease in the spatial resolution and increase in the free carrier absorption. As the optical wavelength difference is in the order of several light wavelengths due to the change of the refractive index in area 17 of the semiconductor component 12, the coherence length L_{Coh} of the light source used should be longer than a few wavelengths λ. Therefore, a laser light source must be used. To produce an interference image which is only produced by the light beam 33 according to FIG. 2 and arises from the double passage through the semiconductor component 12, the coherence length of the laser light source used must be shorter than the optical path length 2·L·n in component 12, where L is the substrate thickness and n is the refractive index of the material of semiconductor component 12. Under these conditions, the multiple reflected beams, such as e.g. 31 and 36 (from FIG. 2) cannot interfere with the reflected reference beam 25 (cf. FIG. 1). The beam 31 reflected by the backside 18 of the semiconductor component 12 therefore will merely brighten the background of the interference pattern and thus slightly reduce the contrast of the interference fringes (the visibility of the interference image). The further reflected beams, such as, e.g., beam 36, result from a four-time (and multiple) passage of the light through the semiconductor component 12. Due to the low intensity, these beams only contribute as background to the useful image. It should be noted that with a much greater coherence length L_{Coh}>>2Ln, the interference image of the component will become much more complex and thus less easy to interpret, since the phase shift will no longer be determined only by the temperature in semiconductor component 12, but also by the dimension L of semiconductor component 12. A further requirement for the light source 1 is a sufficient spatial coherence so as to produce an interference image of high contrast over the entire imaging area.

The relation between the spatial profile in the region 17 within semiconductor component 12 and the change in the refractive index and the morphology of the topside 23 of semiconductor component 12 will be explained by way of FIGS. 3a to 3e. FIGS. 3a and 3b represent an example of the lateral view and a cross-section through a component 12. In region 51, there exists a step in the semiconductor component 12, producing a longer optical path compared to the other regions. FIG. 3c shows the profile of the phase shift in a component 12 due to this difference in the length of the optical path, which component is in its non-excited state. The phase shift in region 51 is greater than in the remaining regions along section line III-III according to FIG. 3a. In FIGS. 3a and 3b, an example of a region with a refractive index variation is denoted by 52 and 54 in the lateral view and in cross-section. An example of the profile of the refractive index along line 58 in FIG. 3b, when the component 12 is in its stressed state, is illustrated in FIG. 3d. Instead of the absolute refractive index, also the relative refractive index or the change in the refractive index, respectively, can be illustrated. Assuming an increase in temperature, the refractive index change is positive in regions 52 and 54 in this example. The profile of the phase shift, caused by the surface morphology of the topside 23 of component 12 and the change in the refractive index in region 54 in the stressed state is shown in FIG. 3e.

FIGS. 4a and 5a represent illustrative examples of two-dimensional interference images of semiconductor component 12 in the unstressed and in the stressed state, respectively, with the same structure, surface morphology and refractive index profile as in FIGS. 3a and 3b. The reference mirror 24 is oriented perpendicularly to the reference beam 15 (cf. FIG. 1) so that a single, infinitely large interference fringe forms. The corresponding light intensity profiles along lines IV-IV in FIG. 4a and V-V in FIG. 5a are given in FIGS. 4b and 5b, respectively. The difference in contrast between the areas 64 and 65 in FIG. 4a occurs due to the difference in the optical paths between the region 51 and the remaining region of semiconductor component 12 according to FIG. 3b. The interference image of semiconductor component 12 in the stressed state in FIG. 5a shows additional interference maximums and minimums due to the refractive index change in region 66 (in this case, increase in the refractive index, cf. FIG. 3d). It should be noticed that the shortest distance between two interference maximums (or minimums) corresponds to a phase difference of 2π.

In some cases it will be advantageous for the phase shift evaluation if the interference image has interference fringes. Such images are particularly well suited for the computer-assisted phase shift evaluation with so-called “Fast Fourier Transform” (FFT) algorithms. Interference fringes can be created by slightly tilting the reference mirror 24 so that the light beams 20 and 25 between the beam splitter 8 and the detection unit 41 (in FIG. 1) will no longer be parallel. This produces a phase gradient by which interference maximums and minimums, called interference fringes, are formed. The distance and orientation of the interference fringes depends on the tilting angle of reference mirror 24 relative to reference beam 15. Examples of interference images with interference fringes as they occur in a semiconductor component 12 which has the same morphology and change in refractive index as the one shown in FIGS. 3a and 3b are schematically illustrated for the unstressed and stressed states in FIGS. 6a and 6b. In the unstressed state, the interference fringes in region 67 are shifted due to the difference in the lengths of the optical path between the regions 51 and the remaining regions (in FIG. 3). For the stressed state, the interference fringes are additionally deformed and shifted in region 68 due to the assumed change in the refractive index (as shown in FIG. 3d).

One method of obtaining the phase shift from the interference image is to perform a two-dimensional Fourier analysis of the interference pattern, as illustrated in FIGS. 6a and 6b, and to extract the phase distribution from the result thereof. A further method is to obtain the phase shift directly from the spatial shift of the interference fringes. Both methods are known procedures in the processing of interference images.

FIG. 7 shows the schematic time courses when carrying out the method for optical testing of semiconductor components 12, in which an interference image of a semiconductor component 12 which has been excited by a short stress pulse is produced. According to FIG. 7, the semiconductor component 12 to be tested over time T is subjected to a stress in the form of a stress pulse 70. The usual times T for the stress pulse 70 are between 10 ns and 100 ns, yet also longer pulses may be used. The stress pulse 70 may occur at a random time instant for simulating accidental stresses, or it may be controlled by an external triggering signal. After the detection of the start of the stress pulse 70, preferably after a certain duration t_{D}, the emission of a light pulse 71 with the duration Tₚ is triggered, whereupon the capture of an interference image of semiconductor component 12 in the stressed state for a certain time window which is determined by the length tₚ of the emitted light beam 71 and the delayed time t_{D} will occur. Moreover, an interference image of semiconductor component 12 in the starting state, i.e. in the unstressed state, will be produced and stored. Due to the difference in the phase shift in the interference images for the unstressed and the stressed states, the influence of the stress pulse on the refractive index n in semiconductor component 12 can be calculated. The time trigger is determined by the duration tₚ of light beam 71 and by the time precision during triggering of the light beam 71 in relationship to the beginning of the stress pulse 70.

For a mere qualitative measurement of the position within the component where the internal parameters change in the stressed state without obtaining information on the exact value of the phase shift, it suffices to directly subtract the interference images for the stressed and the unstressed state from each other. The subtracted image will represent the region where the internal component parameters change in the stressed state. By the method according to the invention it is possible to record an interference image of the component in the stressed state during a single stress pulse 70. For this, the image must be produced by means of a single light beam 71. In order to record such an interference image with a camera, the light intensity of the image must be much higher than the sensitivity limit of the camera. This can be realized with a laser light source which achieves a pulse energy in the order of 1 μJ. For imaging the component in a wavelength range λ<1100 nm, a CCD (charged couple device) camera can be used. For imaging in a wavelength range 400 nm<λ<(1800-2200 nm) (typically near 1300 nm), an infrared camera can be used. A further possible solution is to use a focal plane array, which is a CCD-like planar detector of a grid-shaped array of semiconductor detectors, of e.g. InGaAs. Another possibility is the use of a cheaper camera with a vidicon picture tube (e.g. Hamamatsu C5310). The coating of the vidicon picture tube has a long screen memory time (10-100 ms) so that the interference image can be electronically read from the picture tube after the illumination pulse within the screen memory time.

For the illumination of the component at a wavelength λ=1064 nm, a quality-switched (Q-switched) YAG laser can be used. For the illumination in the infrared and visible range, a number of pulsed laser sources are available. For the range of longer wavelengths, a YAG-laser-pumped optical parametric oscillator (OPO) whose wavelength in the infrared range is infinitely variable can be used.

The pulse duration is 5 ns. This laser source has a pulse energy of up to 500 μJ per pulse. The laser light produced has a coherence length of approximately 300 μm. Therefore, the disturbing interference of reflections of the beams 31 and 36 (in FIG. 2) from the substrate backside can be prevented. In this manner, the interference image of the component is exclusively produced by beam 33. Other laser light sources, such as e.g. high power laser diodes, could also be suitable for illuminating the semiconductor component.

FIG. 8 shows a block diagram of a variant of an arrangement for optical testing of semiconductor components 12 for controlling the time sequence of stress pulses and light pulses if the stress pulse occurs time-controlled. A pulse generator 73 produces a signal which triggers a stressing device 74 for producing a stress pulse. The stress pulse produced in the stressing device 74 acts on the semiconductor component 12 to be tested. The pulse generator 73 or the stressing device 74, respectively, is connected with a means 76 for controlling the light source 1, which may, e.g., contain a delay stage and emits a light beam onto the semiconductor component 12 after triggering of the stressing device 74 through the pulse generator 73 after a certain delay, whereupon the interference image of the semiconductor component 12 will be recorded at a predefined time window by the detection system 41. The image captured by a camera can be stored in a memory 81, e.g. a video-tape recorder, and transmitted to a computer 80.

FIG. 9 shows a block diagram of an arrangement varied relative to FIG. 8 for optically testing semiconductor components 12, wherein the stress pulse occurs at a random, non-controllable time. In this context, “random” means that the temporal uncertainty for the occurrence of the stress pulse is within a time window which is much longer than the duration of the stress pulse itself. The stressing device 74 is excited by a pulse triggering unit 82 which, in the simplest case, may be formed by a switch which at a random time excites the stressing device 74 for emitting a stress pulse and allows it to act on the semiconductor component 12. The stressing unit 74 is connected to a device 76 for controlling the light source 1 so that after the detection of the triggering of the stress pulse, e.g. after a pre-determined delay time, a light pulse can be triggered by the light source 1, whereupon the interference image forming can be captured by the detection system 41 and optionally, stored in a memory 81 and further processed in a computer 80.

FIG. 10 shows the time courses when using a testing arrangement according to FIG. 9, wherein the stress pulse 70 is triggered for a certain duration T and at a random time tₛₜₐᵣₜ. After the detection of the beginning tₛₜₐᵣₜ of the stress pulse 70, after a certain delay time T_{fix}, the emission of a light pulse 71 with a pre-determined duration tₚ will occur. The random stress pulse 70 may, e.g., occur as a consequence of electro-magnetic disturbances. They can also be pulses produced by electrostatic discharge (ESD). This discharge event can usually be simulated by discharging a charged coaxial transmission line by a mechanical switch. The typical duration T of such a pulse 70 is 100 ns-500 ns, depending on the length of the coaxial transmission line. Switching of the mechanical switch typically occurs with a temporal indeterminateness of 5 μs. Thus, the stress pulses 70 produced by discharging such a coaxial transmission line can be considered as occurring random in terms of time. The minimal time delay T_{fix} usually is constant and is determined by the control electronics and optical processes within the source of illumination. In principle, the existence of this delay T_{fix} would prevent imaging of the component 12 before this time. To circumvent this limitation, the stress pulse 70 can be delayed with a delay unit 86 so that a stress pulse 7′ delayed by the time t_{yy} will be applied to component 12 (cf. FIG. 10). The methodology of the pulse delay in the delay unit 86 will depend on the type of stress pulse 70 and is prior art. For example, in the instance of the electrostatic discharge of a co-axial transmission line, a delay unit 86 may be realized by adding on an additional coaxial transmission line of a certain length.

Besides temporally triggered images of the change in the refractive index n under high current stress which will lead to a great variation of the phase shift measured, the apparatus can also be used for interferometric measurements of slight variations of the refractive index under direct current conditions. The method can be used to localize defects in the semiconductor components 12 or complex circuits, provided that the defect causes a local energy loss in the semiconductor. An example of a defect may be a short circuit in the metalization or a localized pn-junction leak. At first, an interference image of the sample in the unstressed state is taken. In this situation, the reference mirror 24 will be oriented perpendicularly to the reference beam 15 (cf. FIG. 1). Then the component 12 will be put into a different state by using the required direct current or by repetitive activation, and the interference image is recorded. The two interference images are subtracted, which results in a differential image in which the region in which the heat dissipation (damage localization) occurs becomes clearly visible.

With the above-described invention, interference images of semiconductor components can be recorded for certain time windows, while the component 12 is in a certain state. For some applications, however, it is necessary to record the evolution of internal parameters, such as temperature or free carrier density during a stress pulse at one or several time windows. FIG. 11 shows a block diagram of a variation of the arrangement according to the invention for optically testing semiconductor components 12, in which the light source 1 emits a light beam 2 onto a semiconductor component 12 to be tested, and the interference image forming is recorded by a detection system 41. A pulse generator 73 produces a signal which is transmitted by a stressing device 74 for emitting a stress pulse to the semiconductor component 12 to be tested. The pulse generator 73 is connected to a control device 76 for controlling the light source 1. The light source 1 produces light beams 2 at defined time windows, wherein each light beam may have different light parameters, such as, e.g., polarization or wavelength. The detection system 41 includes a beam splitter 126 which separates the light beams 2 originating from the light source 1 into individual beams, according to their different light parameters, such as, e.g., light polarization or wavelength. The image of each individual beam is recorded by individual cameras 22 and stored in memories 81. A comparing unit 133 formed, e.g., by a computer, may serve for automatically comparing the different interference images.

FIG. 12 shows the time courses when using an arrangement according to FIG. 11, wherein two light pulses 71 are emitted by the light source 1 after the stress pulse 70 has occurred, and the associated interference images are recorded by different cameras.

FIG. 13 shows one realization of an arrangement according to FIG. 11, in which the light parameters for distinguishing the light beams 2 emitted by the light source 1 are states of polarization. The polarization is achieved by separating the light beams emitted by the light source 1 and controlled delaying in a polarizer 165. The beam splitter 126 consists of a polarizing beam splitter 166 which separates the light beams containing the interference image into two beams of different polarizations which are recorded by respective cameras 22.

FIG. 14 shows a variant of an arrangement according to FIG. 11, in which the light source 1 is divided into two light sources 180 and 182 with different wavelengths, whose light beams are combined in a beam-splitter 185 and directed to the semiconductor component 12. In the beam splitter 126, a beam splitting occurs in a dichroic beam splitter 189 which is highly transmitting for one wavelength and highly reflecting for the other wavelength.

One further possible way of realizing a beam splitter 126 according to FIG. 11 can be realized by appropriate frequency filters which select the wavelength range for the respective beams and are related to different time windows.

In the methods and set-ups described before for producing sample images at certain time windows, a pulsed light source 1 (individual light source or multi-beam light source) was used together with slow imaging cameras. The time resolution is determined by the duration and the time delay of the emitted light pulses. Another set-up for recording the interference at different time windows during one stress pulse on semiconductor component 12 is schematically depicted in FIG. 15. In this method, the component 12 is illuminated by a light beam which has a nearly constant amplitude, while the component 12 is in the different stress states. The time resolution of this method is determined by the time-dependent recording of the sample images during pre-defined time windows by so-called “gated” cameras. A gated camera records images only at time windows which are activated by an electronic gate. In this instance, the detection system 41 consists of several cameras 22 which are supplied by a beam splitter system 320 with the respective interference images in the respective time windows. To control the gated cameras 22, a time control unit 331 is provided. Finally, the recorded interference images are transmitted for further processing in a computer 133.

FIG. 16 shows the time courses when using an arrangement according to FIG. 15, wherein interference images are recorded at four times during one stress pulse 70. For this purpose, the light source emits a light pulse 71 for a duration which is longer than the duration of the stress pulse 70, and the cameras 22 are activated at certain times during emission of the light pulse 71 so that four different interference images are recorded.

It is important to mention here that this invention can also be incorporated in a wafer testing station and that interference images both of individual semiconductor components and also of printed circuits on wafer level can be imaged therewith.

1. A method for optically testing semiconductor components of a certain thickness by using an optical interference system with at least one light source (1) for emitting a monochromatic light beam having a wavelength for which the material of the semiconductor component is at least partially transparent, wherein the light beam is split into a reference beam and a sample beam, the sample beam is directed towards the semiconductor component and, with the help of a detection system, the images produced by interference of the light beam reflected by the semiconductor component with the reflected reference beam are recorded for a two-dimensional illustration of certain internal physical properties of the semiconductor component, wherein the sample beam is directed at the backside of the semiconductor component to be tested and reflected at its topside, and at least two interference images are detected in temporal sequence under different states of stress of the semiconductor component, wherein the coherence length of the light beam split into the sample beam and the reference beam is shorter than the optical path length 2.L.n of the semiconductor component to be tested, where L is the thickness and n is the mean refractive index of the material of the semiconductor component.

2. A method according to claim 1, wherein the diameter of the sample beam is adjusted to the area of the semiconductor component to be investigated.

3. A method according to claim 1, wherein the detected interference images are stored.

4. A method according to claim 1,
wherein the different states of stress are caused by the excitation of the semiconductor component with at least one external stress, by which the certain properties of the semiconductor component are influenced, and that at least one light beam is emitted during the stress and a corresponding interference image is detected.

5. A method according to claim 4, wherein the external stress is caused by high voltage or high power pulses.

6. A method according to claim 4, wherein the external stress is caused by flashes of light.

7. A method according to claim 4, wherein several light beams are emitted before, during and/or after the stress and the corresponding interference images are detected.

8. A method according to claim 4, wherein the stress is detected and at least one light beam is triggered at a pre-defined time after the detection of the stress.

9. A method according to claim 4, wherein a light beam is emitted at least during the stressed state, and several interference images are detected before, during and/or after the stressed state.

10. A method according to claim 4, wherein the backside of the semiconductor component is polished before optical testing.

11. A method according to claim 4, wherein the interfering light beams are split, and the split partial beams are recorded by individual detection systems.

12. A method according to claim 11, wherein the detection system is activated in dependence on the emitted light beams.

13. A method according to claim 11, wherein the emitted light beams have different polarizations, preferably orthogonal polarization.

14. A method according to claim 11, wherein the emitted light beams have different wavelengths.

15. A method according to claim 1, wherein the reference beam is reflected at a reference semiconductor component, wherein the reference semiconductor component is identical with the semiconductor component to be tested.

16. A method according to claim 1, wherein the intensity of the reference beam is attenuated.

17. A method according to claim 1, wherein the position of the reflected reference beam is changed, so as to optimize the interference image.

18. A method according to claim 1, wherein the interference images are automatically compared to each other.

19. An arrangement for optically testing semiconductor components of a certain thickness with at least one light source for emitting a monochromatic light beam having a wavelength for which the material of the semiconductor component is at least partially transparent, and with a beam splitter for splitting the light beam into a reference beam and a sample beam, and with at least one detection system for recording the two-dimensional images produced by the interference of the light beam reflected by the semiconductor component with the reflected reference beam, wherein the backside of the semiconductor component faces the sample beam, wherein a stressing device for emitting an external stress for the semiconductor component is provided, and that furthermore a memory whose input side is connected to the output of the detection system for storing at least two interference images recorded at time intervals, and a device whose input is connected to the output of the memory for automatically comparing the interference images under different stresses are provided.

20. An arrangement according to claim 19, wherein a device for adjusting the diameter of the emitted light beam for enlarging the diameter is arranged in front of the light source.

21. An arrangement according to claim 19 the stressing device is connected with a device for controlling the light source.

22. An arrangement according to claim 21, wherein the control device comprises a delaying device.

23. An arrangement according to claim 19, wherein the detection system comprises a beam splitter for separating the light beams into individual light beams with different light parameters and one camera each for recording images of these individual light beams.

24. An arrangement according to claim 23, wherein the beam splitter comprises a polarizing device for separating the light beams into individual light beams with different polarization.

25. An arrangement according to claim 23 or 24, wherein the beam splitter comprises dichroic beam splitters for splitting the light beams into individual light beams with different wavelengths.

26. An arrangement according to claim 19, wherein a collimator is arranged upstream of the semiconductor component for parallel adjustment of the sample beam.

27. An arrangement according to claim 19, wherein an attenuator is arranged in the path of the reference beam.

28. An arrangement according to claim 19, wherein a device for changing the position of the reflected reference beam is provided which is formed by a device for tilting the reference mirror.

29. An arrangement according to claim 19, wherein the device for automatically comparing the interference images recorded in temporal sequence is formed by a computer.

30. An arrangement according to claim 19, wherein the light source is formed by a laser.

31. An arrangement according to claim 19, wherein the detection device includes a camera, e.g. a vidicon or CCD camera.

32. An arrangement according to claim 19, wherein the detection device includes a two-dimensional multi-element detector.

33. A method according to claim 17, wherein the position of the reflected reference beam is changed by tilting the reference mirror.

34. An arrangement according to claim 20, wherein said device for adjusting the diameter of the emitted light beam is a beam expander.

35. An arrangement according to claim 31, wherein said camera is a vidicon camera.

36. An arrangement according to claim 31, wherein said camera is a CCD camera.
